(19) United States
(12) Patent Application Publication
(10) Pub. No.: US 2006/0146172 A1
(43) Pub. Date: Jul. 6, 2006

(54) Miniaturized utility device having integrated optical capabilities

(76) Inventors: Stephen C. Jacobsen, Salt Lake City, UT (US); David T. Markus, Salt Lake City, UT (US); David P. Marceau, Salt Lake City, UT (US); Ralph W. Pensel, Sandy, UT (US); Shayne M. Zurn, Salt Lake City, UT (US)

Correspondence Address: THORPE NORTH & WESTERN, LLP., 8180 SOUTH 700 EAST, SUITE 200, SANDY, UT, 84070, US

(21) Appl. No.: 11/292,902

(22) Filed: Dec. 1, 2005

Related U.S. Application Data
(63) Continuation-in-part of application No. 10/391,513, filed on Mar. 17, 2003.
(63) Continuation-in-part of application No. 10/391,490, filed on Mar. 17, 2003.
Application No. 10/391,513 is a continuation-in-part of application No. 10/391,489, filed on Mar. 17, 2003.
(60) Provisional application No. 60/632,827, filed on Dec. 2, 2004.
(60) Provisional application No. 60/431,261, filed on Dec. 6, 2002.
(60) Provisional application No. 60/365,561, filed on Mar. 18, 2002.
(60) Provisional application No. 60/365,692, filed on Mar. 18, 2002.

(51) Int. Cl. H04N 5/225

(52) U.S. Cl. 348/340

(57) ABSTRACT

A miniaturized utility device having integrated optical capabilities for use on a high aspect ratio system, wherein the miniaturized utility device comprises: (a) a micro camera comprising a solid state micro imaging device including, as an integral structure, an imaging array electrically coupled to a conductive pad, wherein the solid state imaging device further includes at least one utility aperture passing therethrough, and a lens optically coupled to the imaging array; and (b) a micro utility instrument configured for coordinated operation with the imaging device at a common local site, wherein the micro utility instrument is configured to perform a designated function viewable, preferably in real-time, via a camera image generated by the micro camera.

### RELATED APPLICATIONS

This continuation in-part application claims priority to U.S. Provisional Patent Application No. 60/632,827, filed Dec. 2, 2004 in the United States Patent and Trademark Office, and entitled, “Miniaturized Utility Device Having Integrated Optical Capabilities” which application is incorporated by reference in its entirety herein. This a continuation-in-part application also claims priority to U.S. patent application Ser. Nos. 10/391,513, 10/391,490, and 10/391,489, each filed Mar. 17, 2003, and each of which claim priority to U.S. Provisional Patent Application Nos. 60/431,261, filed Dec. 6, 2002; 60/365,561, filed Mar. 18, 2002; and 60/365,692 filed Mar. 18, 2002, each of which are incorporated by reference in their entirety herein.

### FIELD OF THE INVENTION

The present invention relates to miniaturized imaging devices that are particularly suited to viewing beyond small openings and traversing small-diameter areas, and more particularly to miniaturized imaging devices whose operation is coordinated with one or more miniaturized utility instruments that allow the user to perform a utilitarian function viewable in real-time by a camera image formed by the imaging device.

### BACKGROUND OF THE INVENTION AND RELATED ART

The ability to enter, explore, and perform one or more operations within a micro environment has improved in recent years. This is especially true in the medical field where the micro environment is a lumen or cavity or other environment in the human body, such as an artery, vein, organ, etc. Typical lumen exploration and the performance of an operation or function therein has been made possible by the advent of various high aspect ratio systems, such as guidewires and/or catheters that are capable of having a distal end inserted into the lumen with the control of the high aspect ratio system taking place at the proximal end. Such high aspect ratio systems have advanced to the point of supporting various micro utility instruments configured to perform one or more utilitarian functions within the lumen or cavity space. However, due to the enclosure and small size of the micro environment, visual guidance of the high aspect ratio system, as well as the visual capabilities used to perform the utilitarian function have been limited.

One example of a guidance system used in coronary catheterization is fluoroscopy, which is a real-time X-ray technique widely used to position devices within the vascular system of a patient. For visualizing a totally occluded artery, biplane fluoroscopy can be used, wherein the interventional practitioner observes two real-time x-ray images acquired from different angles. Biplane fluoroscopy, however, is unreliable, costly and slow.

Another way of imaging the coronary arteries and surrounding tissues is intravascular ultrasound, which employs an ultrasonic transducer in the distal end of a catheter. The catheter may be equipped with an ultraminiature, very high frequency scanning ultrasonic transducer designed to be introduced into the lumen of the diseased artery. However, a drawback to this system is that the stenosis is often so severe that the transducer will not fit into the are that the interventional practitioner needs to explore the most. Indeed, if the occlusion is too severe to be crossed by a guide wire, it may be too difficult to steer the transducer into the segment of greatest interest. Additionally, an attempt to force an imaging catheter into a severely stenosed artery may have undesirable consequences. Alternatively, the intravascular ultrasonic catheter can be placed in a vein adjacent the occluded artery. Because venous lumina are slightly broader than arterial lumina and rarely, if ever, stenosed, a larger transducer may be employed. Depending on its configuration, a larger transducer may acquire images over greater distances, with finer resolution, or both. However, there is not always a vein properly situated for such imaging.

Perhaps the most inherent drawback to each of these systems is their unilateral application. These guidance and/or viewing systems are first inserted into the lumen for exploration purposes only. In the event further procedure is needed, such as to perform one or more operations within the lumen, either the exploratory system must be first withdrawn or retracted from the lumen and a operational system inserted in its place, or a second, independently operated and controlled operational or performance system (i.e., one capable of performing one or more utilitarian functions due to the support of one or more utility instruments) must be fed into the lumen concurrently with the exploratory system. Either way, these methods are extremely intrusive to the patient, they add additional time and expense to the procedure, and they are still limited in their viewing or image generating capabilities.

### SUMMARY OF THE INVENTION

In light of the problems and deficiencies inherent in the prior art, the present invention seeks to overcome these by providing a miniaturized utility device configured to perform a viewable utilitarian function within a lumen.

Although several objects of some of the various exemplary embodiments have been specifically recited herein, these should not be construed as limiting the scope of the present invention in any way. Indeed, it is contemplated that each of the various exemplary embodiments comprises other objects that are not specifically recited herein. These other objects will be apparent to and appreciated by one of ordinary skill in the art upon practicing the invention as taught and described herein.

In accordance with the invention as embodied and broadly described herein, what is featured is a miniaturized utility device having integrated optical capabilities, preferably for use on a high aspect ratio system, wherein the miniaturized utility device comprises: (a) an imaging device comprising a utility guide supported at the distal end of a high aspect ratio system, wherein the utility guide has a plurality of utility apertures formed therein; a solid state imaging device carried by the utility guide, wherein the solid state imaging device has an imaging array on a top surface, and a conductive element on a side surface, wherein the imaging array is electrically coupled to the conductive element; (b) a lens optically coupled to the imaging array to form a micro camera; (c) a micro utility instrument operably supported within one of the utility apertures of the utility guide for coordinated operation with the micro camera at a local site, wherein the micro utility instrument is configured to perform a designated function viewable in real-time via a camera image generated by the micro camera; and (d) an umbilical carried by at least one of the apertures and comprising a plurality of transfer elements, including a conductive line, for operably connecting the micro camera and the micro utility instrument, wherein the conductive line is electrically coupled to the conductive element on the side surface of the solid state imaging device.

The present invention further features a miniaturized utility system having integrated optical capabilities for use on a high aspect ratio system, wherein the miniaturized utility system comprises: (a) a utility guide supported at a distal end of a first high aspect ratio system, wherein the utility guide has a plurality of utility apertures formed therein; (b) a solid state imaging device carried by the utility guide, wherein the solid state imaging device comprises an imaging array on a top surface, and a conductive element on a side surface, such that the imaging array is electrically coupled to the conductive element; (c) a lens optically coupled to the imaging array to form a micro camera; and (d) a micro utility instrument operably supported on a distal end of a second high aspect ratio system configured to interact with the first high aspect ratio system to provide coordinated operation of the micro utility instrument with the micro camera at a local site, wherein the micro utility instrument is configured to perform a designated function viewable in real-time via a camera image generated by the micro camera.

The present invention still further features a miniaturized utility device having integrated optical capabilities for use on a high aspect ratio system, wherein the miniaturized utility device comprises: (a) a micro camera comprising a solid state imaging device including, as an integral structure, an imaging array electrically coupled to a conductive pad, wherein the solid state imaging device further includes at least one utility aperture passing therethrough; a lens optically coupled to the imaging array; and (b) a micro utility instrument configured for coordinated operation with the imaging device at a local site, wherein the micro utility instrument is configured to perform a designated function viewable, preferably in real-time, via a camera image generated by the micro camera.

The present invention still further features a miniaturized utility device having integrated optical capabilities comprising: (a) a plurality of solid state imaging devices supported along a length of a high aspect ratio system, each of the solid state imaging devices comprising at least one imaging array disposed on a top surface, and a conductive element on a side surface, wherein the imaging array is electrically coupled to the conductive element; (b) a plurality of lenses optically coupled to the imaging arrays to form a plurality of micro cameras; (c) a plurality of micro utility instruments configured for coordinated operation with the micro cameras at a plurality of local sites, wherein each of the micro utility instruments are configured to perform a designated function viewable in real-time via a camera image generated by the micro cameras; and (d) a plurality of transfer elements for operably connecting the micro cameras and the micro utility instruments.

The present invention also features various methods of operation. In one exemplary embodiment, the present invention features a method of operating a miniaturized utility device having optical capabilities, wherein the method comprises: (a) optically coupling a lens to an imaging array of a solid state imaging device to form a micro camera supported on a high aspect ratio system; (b) defining a plurality of conductive paths; (c) powering the solid state imaging device through a first of the conductive paths; (d) coordinating, at a local site, the performance of a utilitarian function with the operation of the micro camera, wherein the utilitarian function is performed by a micro utility instrument supported by the high aspect ration system; (e) transmitting a signal from the solid state imaging device through another conductive path, wherein the signal corresponds to a captured image of the local site or the targeted object at which the utilitarian function is being performed; and (f) processing the signal received from the solid state imaging device to form a camera image of the local site or the targeted object.

Another method featured is a method for performing a viewable utilitarian function at one or more local sites within a lumen comprising: (a) inserting a high aspect ratio device into a luminal opening, wherein the high aspect ratio system comprises at least one micro camera including a lens optically coupled to an imaging array of a solid state imaging device; (b) illuminating, at least partially, a local site around the lens within or beyond the luminal opening; (c) receiving light or photon energy in the lens reflected by contents within or beyond the luminal opening, thereby providing focused light or photon energy at the imaging array; (d) coordinating, at the local site, the performance of a utilitarian function with the operation of the micro camera, wherein the utilitarian function is performed by a micro utility instrument supported by the high aspect ratio system; (e) converting the focused light or photon energy to digital data that corresponds to a captured image of the local site at which the utilitarian function is being performed; and (f) processing the digital data into a camera image of the local site for viewing on a viewing source remote from the micro camera.

In each of the embodiments, the lens may comprise any type of lens, but is preferably a GRIN lens. In addition, the micro utility instrument may be selected from a variety utility instruments from a variety of applications. However, the most common applications anticipated by the present invention relate to the medical field, such as interventional medicine, and thus will utilize suitable micro utility instruments developed for this field.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a block diagram of an exemplary miniaturized utility system supporting a miniaturized utility device having integrated optical capabilities made possible by an imaging device that functions is a coordinated manner with one or more utility instruments to generate a camera image of the utilitarian function being performed by the utility instrument;

FIG. 2 illustrates an alternative exemplary embodiment of a miniaturized utility device according to the present invention, in which the imaging device or micro camera is supported at the distal end of a guidewire that is initially fed or inserted into an anatomical lumen or cavity, followed by a catheter having one or more utility instruments supported thereon, wherein the guidewire and the catheter engage to provide coordinated operation of the utility instrument and the micro camera;

FIG. 3 illustrates a detailed view of a catheter configuration, wherein the imaging device is located at the distal tip of the catheter and includes a utility guide for supporting or carrying an umbilical used to house the collective assembly of individual transfer elements (e.g., electrical wires or conductive lines, fluid bearing tubes, fiber optic light conductive elements, etc.) that facilitate the operation and control of the imaging device and any utility instruments;

FIG. 4 illustrates an exemplary utility guide for use with a SSID according to one exemplary embodiment of an imaging device for use with a miniaturized utility device of the present invention;

FIG. 5 illustrates one exemplary embodiment of a SSID for use with the miniaturized utility device of the present invention;

FIG. 6 illustrates an imaging device or system according to one exemplary embodiment for use with the miniaturized utility device of the present invention;

FIG. 7 illustrates another exemplary embodiment of a SSID for use with the miniaturized utility device of the present invention;

FIG. 8 illustrates an imaging system according to another exemplary embodiment for use with the miniaturized utility device of the present invention;

FIG. 9 illustrates one exemplary embodiment of a micro utility device having an imaging system and two utility instruments supported thereon in the form of forceps and a light source;

FIG. 10 illustrates another exemplary embodiment of a micro utility device having an imaging system and two utility instruments supported thereon in the form of a fluid disperser and a suction device;

FIG. 11 illustrates another exemplary embodiment of a micro utility device having an imaging system and a single utility instrument supported thereon in the form of a laser device; and

FIG. 12 illustrates another exemplary embodiment of a micro utility device having an imaging system and two utility instruments supported thereon in the form of an acoustical device and an acoustical sensor.

### DETAILED DESCRIPTION OF EXEMPLARY EMBODIMENTS

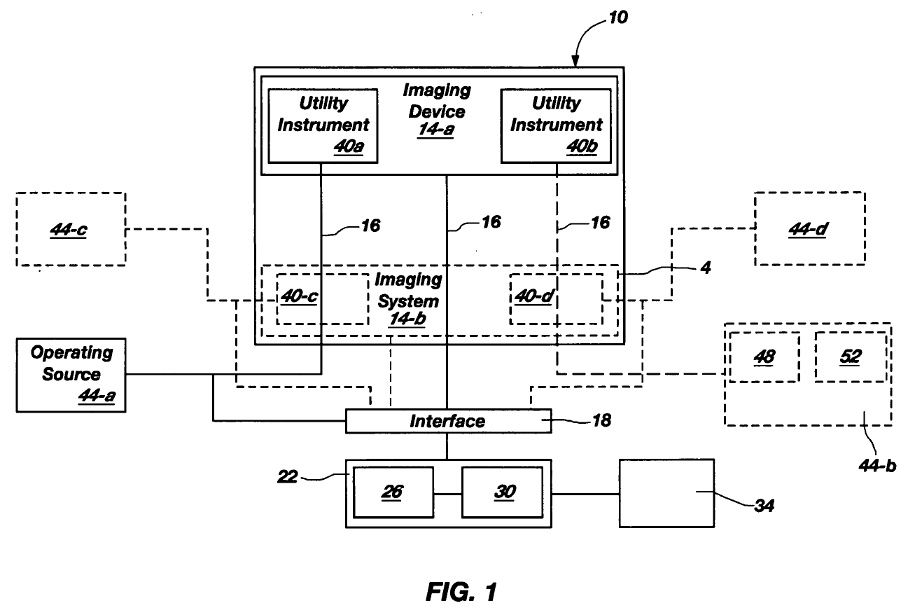

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art practice the invention, it should be understood that other embodiments may be realized and that various changes to the invention may be made without departing from the spirit and scope of the present invention. Thus, the following more detailed description of the embodiments of the present invention, as represented in FIGS. 1 through 12, is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

Generally, the present invention describes a method and system for operating a miniaturized utility device having one or more cameras situated thereon for the purpose of performing a viewable utilitarian function at one or more local sites within a lumen.

Definitions

It must be noted that, as used in this specification and the appended claims, singular forms of “a,” “an,” and “the” include plural referents unless the context clearly dictates otherwise.

The phrase “solid state imaging device,” “SSID,” or “SSID chip,” as used herein, shall be understood to mean in the exemplary embodiments a substrate carrying an imaging array or pixel array for gathering image data, and can further comprise conductive pads electrically coupled to the imaging array, which facilitates electrical communication therebetween. In one embodiment, the SSID can comprise a silicon or silicon-like substrate or amorphous silicon thin film transistors (TFT) having features typically manufactured therein. Features can include the imaging array, the conductive pads, metal traces, circuitry, etc. Other integrated circuit components can also be present for desired applications. However, it is not required that all of these components be present, as long as there is a means of gathering visual or photon data, and a means of sending that data to provide a visual image or image reconstruction. In some embodiments, the SSID can include utility apertures therethrough for carrying various utilities.

The term “lumen,” as used herein, shall be understood to mean any type of conduit or ducted structure including, anatomical structures (e.g., veins, arteries, chambers, etc.), pipes, ducts, and other similar types.

The term “umbilical,” as used herein, shall be understood to mean a collection of bundled transfer elements that operate the SSID, or the micro-camera, the utility instrument(s), computer elements, etc. Typically, an umbilical includes a conductive line, such as electrical wire(s), for providing power, ground, clock signal, and output signal with respect to the SSID, though not all of these are strictly required, as well as one or more transfer elements to operate the existing utility instruments, such as transfer elements to operate a light source, temperature sensors, force sensors, fluid irrigation or aspiration members, pressure sensors, fiber optics, microforceps, material retrieval tools, drug delivery devices, radiation emitting devices, laser diodes, electric cauterizers, and electric stimulators, for example. Other utilities will also be apparent to those skilled in the art and are thus comprehended by this disclosure.

The phrase “GRIN lens” or “graduated refractive index lens,” as used herein, shall be understood to mean a specialized lens that has a refractive index that is varied radially from a center optical axis to the outer diameter of the lens. In one embodiment, such a lens can be configured in a cylindrical shape, with the optical axis extending from a first flat end to a second flat. Thus, because of the differing refractive index in a radial direction from the optical axis, a lens of this shape can simulate the affects of a more traditionally shaped lens. Though GRIN lenses are generally shown in the Figures, other lenses can also be used with the present invention, as is known by those skilled in the art.

The phrase “transfer element,” as used herein, as well as similar phraseology, shall be understood to mean any structural element configured or designed or capable of performing a designated transfer function for making operable the micro camera and/or the several utility instruments, namely the transfer of energy, work, fluid, electricity, light energy, sound energy, matter, etc. from one location to another location. For example, in one aspect transfer elements may comprise rigid or flexible tendons configured to perform a mechanical function, such as to selectively transfer a bending force to any segment along the length of the guidewire for steering, bending, and/or torquing the guidewire. In another aspect, transfer elements may comprise electrical conductive lines, such as wires, plasma tubes, etc. configured to transfer electrical current or voltage to one or more discs along the length of the guidewire, as received from a power source, for the purpose of powering various systems or devices, such as cameras, flashlights, tools, computer circuits, computer processors, etc. In still another aspect, transfer elements may comprise tubular structures configured to transfer fluids to one or more discs along the length of the guidewire as received from a fluid source, wherein the supplied fluid may be used for one or more purposes, such as to effectuate local hydraulic or pneumatic actuation of a device or system supported by the disc, to supply the necessary fluid to a suitable tool requiring a fluid, to effectuate cooling of a system or device, or any other use as recognized by one skilled in the art. A fluid transfer element may also be a negative pressure transfer element configured to transfer fluid away from a local site. In still another aspect, a transfer element may further transmit light or energy used to provide illumination at a local site, or to provide laser energy or laser light for the carrying out of various tasks, such as ablation. A transfer element may comprise any structure or any type of structure extending along the length of the guidewire, either in segments or as a single, continuous or uninterrupted length, and that is attached or inserted through one or more discs, preferably in an offset or radial manner from the neutral axis.

The phrase “coordinated operation,” as used herein, shall be understood to mean the concurrent, simultaneous, or synchronized operation of any suitable micro camera with the operation of the one or more micro utility instruments to enable the utilitarian function being performed by the utility instrument to be viewable by a camera image generated by the imaging system or micro camera.

The phrase “micro utility instrument,” as used herein, shall be understood to mean any type of micro system or device configured to or capable of performing a utilitarian function on a micro scale within a micro environment, such as within the human body.

The phrase “camera image,” as used herein, shall be understood to mean real-time video images or one or more still images as generated by the micro camera discussed herein, wherein the image captures the area or environment in which the utilitarian function is being performed, and/or the object on which the utilitarian function is being performed.

The following more detailed description is divided into sections for the convenience of the reader, as well as for efficiency in presenting the details of the present invention. As such, these sections are not to be construed as limiting in any way.

Miniaturized Utility Device Having Integrated Optical Capabilities

The present invention features a miniaturized utility device configured for coordinated operation with one or more miniaturized imaging devices or micro cameras, wherein the utility device is capable of performing a utilitarian function viewable in real-time via a camera image generated by the imaging device. The imaging device generates a pre-determined or adjustable camera image of the area or environment in which the utility device is operating, in addition to or in the alternative the subject of the utilitarian function, thus allowing the operator to simultaneously view and perform the utilitarian function.

FIG. 1 illustrates a block diagram of an exemplary miniaturized utility system in the form of a high-aspect ratio system supporting a miniaturized utility device 10 having integrated optical capabilities made possible by an imaging device or system 14 that functions in a coordinated manner with utility instruments 18 to generate a camera image of the utilitarian function being performed by the utility instrument 18. Thus, prior to, during, and subsequent to the execution or performance of a utilitarian function, a user, controlling the utility device 10 either proximate the lumen or from a remote location (depending upon the connection and setup configuration), is able to view the surrounding local site in, and the object on, which the utilitarian function is to be performed. Viewing is made possible by one or more imaging systems 14 being positioned or located at the site of interest, which imaging system 14 may be configured or adapted to provide support for the utility instrument 18 performing the utilitarian function.

As shown, imaging device 14 is embodied in the distal tip of a high aspect ratio system, shown as catheter 4, with utility instruments 40-a and 40-b supported on the imaging device 14 at the tip of the catheter 4. It is noted that the catheter 4 may comprise various other imaging systems and supported utility instruments along its length, not just at the tip. In such an embodiment, the user, via use of the catheter 4, may be able to perform simultaneous, synchronized, and/or random coordinated operations or utilitarian functions within a lumen, depending upon the particular imaging systems and utility instruments present and the timing in which these are activated. The use of multiple imaging systems with multiple utility instruments is illustrated in FIG. 1, wherein imaging system 14-b coordinates operation with utility instruments 40-c and 40-d, which are operably connected to operating sources 44-c and 44-d, respectively. Thus, the operation of imaging system 14-b can be coordinated with utility instruments 40-c and 40-d, while the operation of imaging system 14-a can be coordinated with utility instruments 40-a and 40-b, in any manner desired.

The imaging device 14 comprises a miniaturized micro camera. In one exemplary embodiment, the imaging device 14 utilizes a solid state imaging device. Imaging device 14 is operably connected to interface 18 that functions to supply power to the imaging device 14, as well as to receive the signals generated by the imaging device and to direct digital image signals to processor 26 of computer 22 via a transfer element 16, which may comprise one or more electrical conductive lines. Processor 26 is configured to control the imaging system 14 to create or generate a camera image of the area adjacent a utility device, and to process the digital image signals corresponding to the camera image as received from interface 18. The digital image signals received are further processed and storable (or the camera image is storable) in data storage device 30. The camera image is displayable on output device 34 (e.g., a monitor). The interface 18 can also be configured to control the operating source 44 operably coupled to utility instrument 40 based on control signals from the processor 26 or an operator performing a viewable utilitarian function. As can be seen from the drawings, and as is evident from the description herein, the imaging system 14 is capable of supporting a plurality of utility instruments, each operable to perform a simultaneous or sequential utilitarian functions coordinated with the operation of the imaging system 14.

The miniaturized utility system further comprises at least one utility instrument 40 operably coupled to operating source 44 via transfer element 16. Utility instrument 40 may comprise any miniaturized device, system, etc. capable of performing one or more utilitarian functions as coordinated with the imaging function performed by imaging device 14. Operating source 44 may comprise any source object, system, etc. capable of facilitating the operation of the operably attached utility instrument 40. For example, if utility instrument 40 were a fluid dispenser, operating source 44 may comprise a pump and fluid reservoir combination to direct fluid from the reservoir to the dispensing end of the utility instrument via transfer element 16, which may comprise a tube or other similar fluid carrying structure. Or, if utility instrument 40 were a light, operating source 44 may comprise a power source and transfer element 16 an electrical conductive line. Or, if utility instrument 40 were a pair of micro forceps, operating source 44 may comprise a tendon actuator coupled to various transfer elements 16 in the form of tendons that function to open and close the jaws of the micro forceps upon actuation. In the embodiment in FIG. 1, transfer elements 16 may bundled together and housed or supported in an umbilical, or they may exist as separate elements.

As shown in FIG. 1, utility device 10 comprises a catheter 4 having two utility instruments, namely utility instruments 40-a and 40-b, supported at the distal end of catheter 4. Utility instrument 40-a is generally shown and is capable of comprising any utility instrument. Utility instrument 40-b is shown as comprising a specific utility instrument, namely a fluid dispersing or dispensing instrument operably (or fluidly) coupled to operating source 44-b, which consists of a pump 48 configured to pump fluid from reservoir 52. The fluid stored in reservoir 52 may comprise any suitable fluid, such as an imaging fluid (e.g., a clear saline solution), to be dispensed to the distal tip portion of catheter 4 from reservoir 52 to displace body fluids or other objects as needed to allow imaging device 14 to generate a clearer image and/or to enable more efficient operation of utility instrument 14-a. Pump 48 may be manually actuated by an operator performing the utilitarian function, or it can be automated and electronically controlled so as to dispense fluid on demand according to control signals from the practitioner, sensors, or according to software commands.

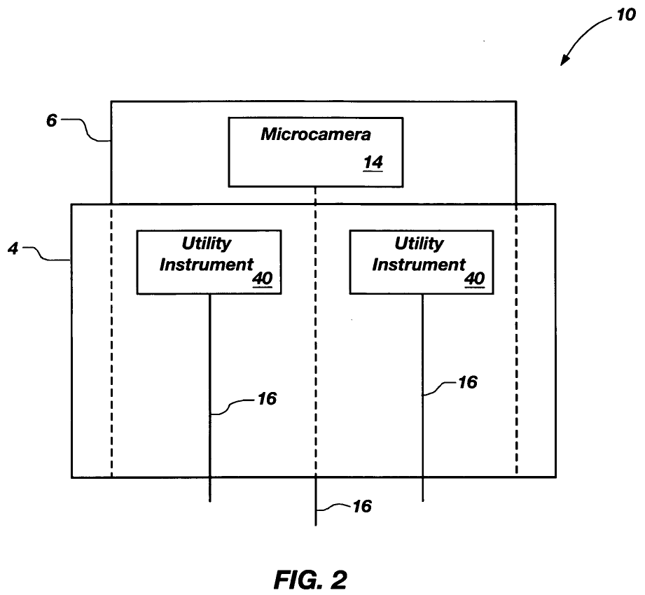

FIG. 2 illustrates an alternative exemplary embodiment of a utility device 10, in which the imaging device or micro camera 14 is supported at the distal end of a first high aspect ratio system, shown as guidewire 6, that is initially fed or inserted into an anatomical lumen or cavity, followed by a second high aspect ratio system, shown as catheter 4, having one or more utility instruments 40 supported thereon. Upon proper alignment and positioning of the first and second high aspect ratio systems, the micro utility instrument of the second high aspect ratio system releasably engages and is supported within the utility aperture of the utility guide of the imaging system supported on the first high aspect ratio system.

The operation of the one or more utility instruments 40 is coordinated with the micro camera 14 so that the utilitarian function performed by the utility instruments 40 are viewable by the micro camera 14 according to a generated camera image, which may be real-time video, stills, or any other captured image. Transfer elements 16 are also supported along the length of the guidewire 6 and the catheter 4 and are of the type suitable to facilitate the function of the micro camera 14, as well as the various utility instruments 40.

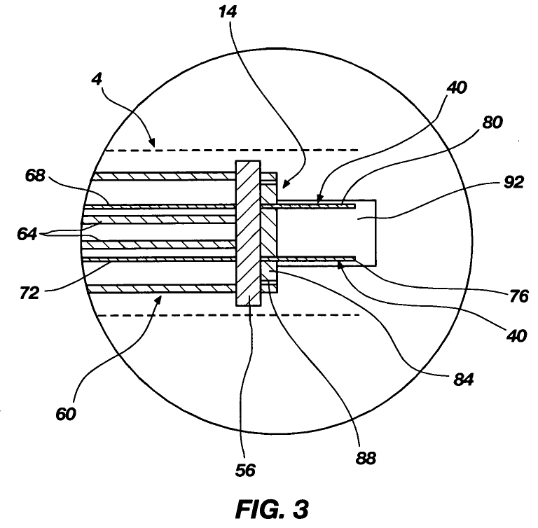

With more specific reference to FIG. 3, the utility device 10 shown comprises a catheter configuration, wherein imaging device 14 is located at the distal tip of catheter 4 and includes utility guide 56 for supporting or carrying the umbilical 60 used to house the collective assembly of individual transfer elements 16 (e.g., electrical wires or conductive lines 64, fluid bearing tubes 68, and a fiber optic light conductive element 72) that facilitate the operation and control of the imaging device and any utility instruments.

The distal tip of catheter 4 includes one or more utility instruments 40, shown here as a light 76 and a fluid dispersing instrument 80. The light source shown is a fiber optic carried by the utility guide. However, other light sources can be used, such as those carried by the SSID discussed below. For example, the SSID can also include light-emitting diodes (LEDs) configured to illuminate the area immediately adjacent the distal tip portion. Other examples of utility instruments that can be carried by the utility guide can include, temperature sensors, force sensors, fluid irrigation or aspiration members, pressure sensors, fiber optics, microforceps, material retrieval tools, drug delivery devices, radiation emitting devices, laser diodes, electric cauterizers, and electric stimulators.

The utility guide 56 can also carry a solid state imaging device or SSID 84 that includes an imaging array (not shown) and conductive pads 88 for coupling the electrical wires 64 to the SSID 84. Though the utility guide and the SSID are shown as two separate units, it is understood that a single integrated unit can also be fabricated, as discussed below. With the SSID in this configuration, a GRIN lens 92 is shown optically coupled to the imaging array of the SSID.

If a GRIN lens 92 is used, the lens can be substantially cylindrical in shape. In one embodiment, the GRIN lens can have a first flat end for receiving light, a second flat end for passing the light to the imaging array, and an outer curved surface surrounded by an opaque coating or sleeve member to prevent unwanted light from entering the GRIN lens. The GRIN lens can be optically coupled to the imaging array by direct contact between the second flat end and the imaging array of the SSID 84. Such direct contact can include an optically transparent or translucent bonding material at the interface between the second flat end and the imaging array. Alternatively, the GRIN lens can be optically coupled to the imaging array of the SSID through an intermediate optical device, such as a fiber optic or a color filter, or any shape optical lens such as a prism or wide angle lens.

The catheter 4 can be configured to be bendable and flexible so as to be steerable within a patient's anatomy and to minimize trauma. For example, the catheter can comprise a micromachined tube at the distal tip portion, and cut-out portions (not shown) can allow for increased flexibility of the tube, and also allow for outflow of an imaging fluid to displace body fluids in the immediate area of the distal tip portion for more clear imaging. Such a micromachined tube can also allow bending to facilitate guiding the catheter to a desired location by selection of desired pathways as the catheter is advanced. The utility device 10 may also be embodied in a guidewire as described and claimed in U.S. application Ser. Nos. ______, filed ______, and entitled, “Segmented Guidewire;” and ______, filed ______, and entitled, “Segmented Guidewire Having an Array of Intelligent Performance Centers,” each of which are incorporated by reference herein. In the case of the guidewire embodiment comprising an array of intelligent performance centers, each disc would be capable of supporting and operating one or more micro cameras and/or one or more micro utility instruments. Thus, the micro utility instruments and the micro camera may be operated locally, as the guidewire or catheter would comprise local energetics, meaning that the mechanical, structural, and other means used to operate and control the micro camera and the micro utility instrument(s) are contained locally within the lumen at respective disc elements with control of these being done via computer or some other way. In this respect, external control and operational elements, such as those found in prior related systems, may be reduced or eliminated. In addition, such an embodiment would be advantageous as it would lessen the number of times required to position the utility device consisting of at least one camera/utility instrument combination into the lumen at a particular local site, thus reducing the degree of intrusion.

The catheter 4 can comprise an internal tension wire adjacent one side of the distal tip portion, which when tensioned, causes the distal tip portion to deflect, as is known in the art. A combination of deflection and rotation of the distal tip portion of the catheter provides steerability of the device. Another alternative for steering the distal tip portion is to provide a micro-actuator (not shown) such as an piezoelectric element which expands or contracts upon application of an electrical current signal. Such an element can be substituted for the tension wire, for example.

As will also be appreciated, while the present invention utility device having optical capabilities is illustrated by the exemplary embodiment of a medical catheter or guidewire having a micro camera and utility instrument supported thereon, these arrangements could be used in other devices, such as visual sensors in other devices, a surveillance apparatus, and in other applications where a very small imaging and utility device can be useful. However, for purposes of discussion herein, the present invention will be described as embodied in a catheter or guidewire configuration.

Moreover, with reference to all of the embodiments described herein, the device contemplated can be very small in size, and accordingly the imaging array of the SSID may have a lower pixel count than would otherwise be desirable. As technology advances, pixel size can be reduced, thereby providing more accurate and suitable imaging arrays that produce clearer images and better data. However, when using a lower number of pixels in an imaging array, the resolution of the image provided by the device can be enhanced through software in processing image data received from the SSID. The processor 26 shown in FIG. 1, can be appropriately programmed to further resolve a scanned image from an imaging array of an SSID, for example, based on information received as the SSID is moved slightly, such as from controlled vibration. The processor can analyze how such image data from the imaging array is altered due to the vibration, and can refine the image based on this information.

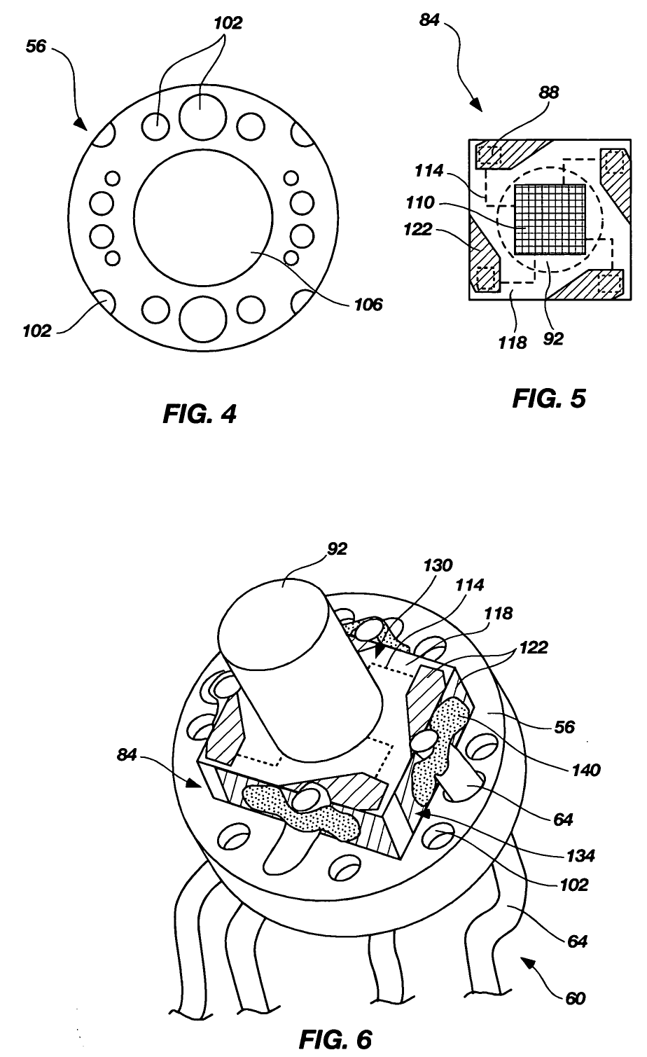

FIGS. 4-8 detail various exemplary imaging systems or micro cameras, or their component parts, for use with the present invention miniaturized utility device. Referring specifically to FIG. 4, an embodiment of a utility guide 56 is shown. The utility guide includes a plurality of utility apertures 102 and a central aperture 106. The utility apertures may be located or positioned in any manner, such as in a position radially offset from a center axis of the solid state imaging device, annularly spaced around the perimeter of the utility guide, or randomly located.

The utility guide can be of any material that will not interfere with the function of the SSID (not shown). For example, the utility guide can be of silicon that has been deep reactive ion etched to form the desired structure. Alternatively, a polymeric material such as SU-8 polymer material manufactured by IBM, Foturan which is a photosensitive glass by Coming, or polymethyl methacrylate (PMMA) molded by Lithographie Galvanoformung Abformung (LIGA) can also be used for forming such a structure. The utility guide has the dual function of carrying the SSID, as well as carrying the utilities provided by the umbilical.

FIG. 5 depicts an embodiment of an SSID 84 that can be used in accordance with embodiments of the present invention. The SSID includes an imaging array 110 electrically coupled to conductive pads 88 by an electrical connection 114. All of these features 110, 88, and 114 are manufactured into a substrate 118 when the SSID is prepared. Additionally, a conductive strip or metal trace 122 is present on the SSID, providing electrical communication between the conductive pads and respective side surfaces (not shown) of the SSID. The positioning of a GRIN lens 92 with respect to the imaging array is also shown.

FIG. 6 depicts an exemplary embodiment of an assembled micro camera that utilizes the utility guide 56 of FIG. 4 and the SSID 84 of FIG. 5. The utility guide includes utility apertures 102 and a central aperture (not shown). The SSID is carried by the utility guide, and can be bound to the utility guide by an epoxy material, anodic bonding, or eutectic bonding. Alternatively, the utility guide can be micromachined by a deep reactive ion etch (DRIE) process by utilizing the SSID as a staring material, and thus, removing the additional step of connecting the utility guide to SSID. The SSID includes conductive strip 122 that provides conductivity from a top surface 130 of the SSID to a side surface 134 of the SSID. Thus, conductive wires 64 of the umbilical 60 can be carried by a utility aperture of the utility guide, and attached to the conductive strip by a bonding joint 140, such as a solder joint, at the side surface. The solder joint can be of a conductive bonding material, such as silver or gold filled epoxy, silver or gold solder, or another suitable adhesive or eutectic conductive substance. Alternatively, the connection between conductive strip and the conductive wires can be through wire bonding, solder bumping, eutectic bonding, electroplating, or conductive epoxy. However, with this configuration, a direct bonding joint having no wire bonding between the conductive strips and the conductive wires can be preferred, as good steerability can be achieved with less risk of breaking electrical bonding. As the conductive strip is electrically coupled to the conductive pads (not shown), and as the conductive pads are electrically coupled to the imaging array (not shown) by an electrical connection 114, electrical coupling between the imaging array and the conductive wires of the umbilical is effectuated.

The SSID can be any solid state imaging device, such as a CCD, a CID, or a CMOS imaging device. The substrate 118 of the SSID 84 can comprise a silicon or silicon-like material or can be an amorphous silicon thin film transistors (TFT) having features typically manufactured therein. Features can include the imaging array (not shown), the conductive pads (not shown), and conductive strips or metal traces 122 (which are typically applied topically after SSID foundry manufacture). Other integrated circuit components can also be present for desired applications, such as light emitting diodes (LEDs) (not shown) for providing light to areas around the lens. As the above described component are exemplary, it is not required that all of these components be present, as long as there is a visual or photon data gathering means, and some means of converting that data to a visual image or a visual reconstruction.

The conductive wires 64, can provide the dual function of guiding the direction the SSID, such as by tensioning, as well as provide electrical contact between any power source/signal processors (not shown) and the SSID, though this dual functionality is not required. Alternatively, steering can be by a micromachined tube, as is known in the art. An example of such micromachined tubing is described in U.S. Pat. No. 6,428,489, which is incorporated herein by reference. In further detail with respect to the umbilical, the conductive wires of the umbilical can provide power, ground, clock signal or control, and output signal to the SSID. Further, the electrical umbilical 60, including conductive wires, can comprise an insulator coating portion around each individual utility, and/or around the umbilical as a whole.

The lens 92, SSID 84, and utility guide 56 of the micro camera can be fused together or bonded together as desired. For example an epoxy, such as a UV cure epoxy, can be used to bond the lens to the imaging array 110 of the SSID. Likewise, an epoxy can also be used to bond the utility guide to the SSID. However, with the use of such epoxy, care should be taken not use a UV light at an intensity that would damage the SSID or other structures of the device.

The micro camera assembly may comprise other embodiments, such as where wherein the lens 92 is held in place by a lens holder. The lens holder can include utility apertures for carrying or guiding utilities, such as light or fluid aspirators/dispensers. The lens holder may also include a lens aperture for supporting the lens. If the lens is a GRIN lens, the lens can be coated with an opaque coating or sleeve on or around the curved surface to prevent light from entering the lens at other than the flat surface that is most distal with respect to the SSID. The lens holder can act, in part, as the opaque sleeve that prevents unwanted light from entering the side, provide the lens holder is fabricated from an opaque material. In this embodiment, the SSID 84 and utility guide 56 are configured similarly as that described with respect to FIG. 6. Specifically, the SSID includes a substrate 118 carrying an imaging array 110 and conductive strips or metal traces 122. However, the utility guide 56 would include utility apertures that are aligned with the utility apertures of the lens holder. Utilities, such as conductive wires (not shown), that are used to power and carry signal with respect to the SSID, need not be carried by the utility apertures of the lens holder, as such conductive wires usually terminate at the SSID. The utility apertures of the lens holder are primarily for carrying utility devices that are used at or near the lens.

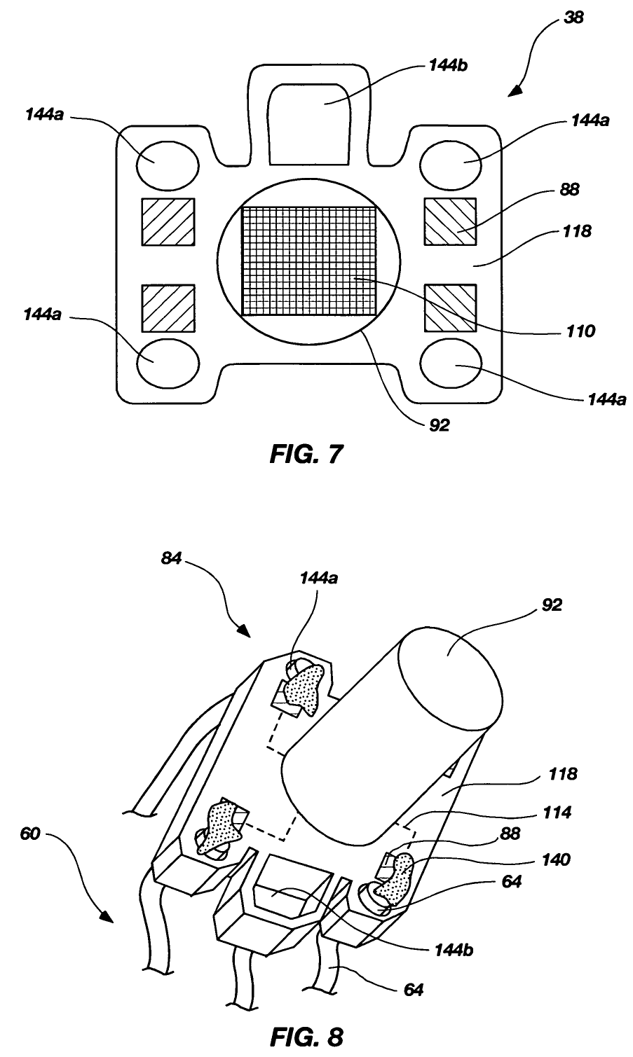

Turning now to FIG. 7, an alternative SSID 84 that is integrated with utility apertures 144a, 144b is shown. The SSID includes a substrate 118 that carries conductive pads 88 and an imaging array 110 fabricated therein. As the SSID includes four similarly sized utility apertures 144-a and one alternately sized utility aperture 144-b, various utility instruments can be carried by the SSID device without the use of a separate utility guide, such as that described with respect to FIG. 6. Lens 92 is shown in hidden lines in its position with respect to the imaging array 110.

FIG. 8 depicts another exemplary imaging system that utilizes the exemplary SSID 84 of FIG. 7. In this embodiment, the SSID includes a substrate 118, which carries an imaging array (not shown), conductive pads 88, and electrical connections 114 between the imaging array and the conductive pads. The SSID is electrically coupled to an umbilical 60 at the conductive pads 88. Specifically, conductive wires 64 of the umbilical are carried by four utility apertures 144a and electrically coupled to the conductive pads 88 by respective solder joints 140. The four conductive wires can be used to provide power, ground, clock signal to the SSID, as well as image signal from the SSID to a remote processor/monitor device (not shown). Only four of the five apertures are used to carry the conductive wires. The larger fifth aperture 144b can carry other utilities such as light sources, fluid aspirators and/or dispensers, temperature sensors, force sensors, pressure sensors, fiber optics, microforceps, material retrieval tools, drug delivery devices, radiation emitting devices, laser diodes, electric cauterizers, and electric stimulators, and the like. The fifth aperture 82b can also carry multiple utility devices, or additional apertures (not shown) can be included in the SSID for carrying separate utilities. Lens 92 can be positioned with respect to the SSID to be optically coupled to the imaging array. All of the disclosure related to the lens, SSID, umbilical, apertures, and the like, described in other embodiments, such as in FIG. 6, can also be applicable to this embodiment as well.

Other details regarding the manufacture, use, and various alternative embodiments of the imaging systems or devices just described and their component parts are set forth in U.S. application Ser. No. 10/391,513, filed Mar. 17, 2003; Ser. No. 10/391,490, filed Mar. 17, 2003; and Ser. No. 10/391,489, filed Mar. 17, 2003, each of which are incorporated by reference herein in their entirety.

The following examples illustrate various exemplary embodiments of the present invention utility device with its integrated optical capabilities made possible by the coordinated operation of an imaging system or micro camera. These Examples are not intended to be all encompassing or limiting in any way. Indeed, one skilled in the art will recognize other embodiments in which the present invention may be practiced, as well as several different utility instruments that may be used with the micro camera presented herein, although such embodiments and utility instruments are not specifically discussed herein.

Although not required, it is contemplated that many of the utility instruments discussed below will be operated in conjunction with a light or light source capable of illuminating the local site or area in which the utilitarian function is to be performed, as well as the specific subject of the utilitarian function, thus enabling the micro camera to capture a suitable viewing image.

### EXAMPLE ONE

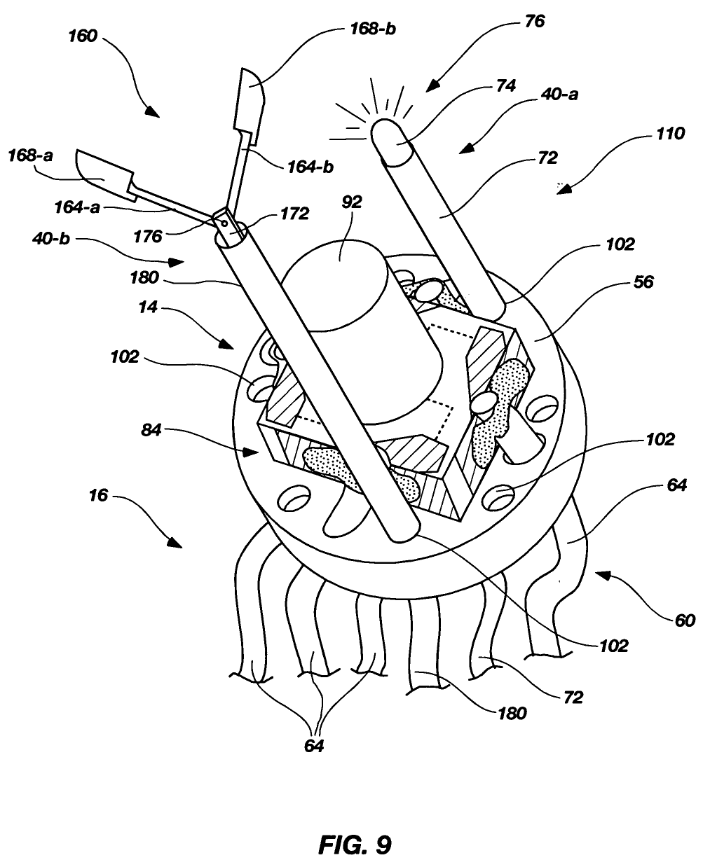

FIG. 9 illustrates a utility device 110 according one exemplary embodiment of the present invention. In this particular embodiment, utility device 110 comprises an imaging system 14 (or micro camera) as embodied and described in FIGS. 4-6, namely an SSID 84 and lens 92 combination supported on a utility guide 56 having a plurality of utility apertures 102 formed therein, and operated via conductive lines 64 (see FIGS. 4-6 for description). Although not shown, it should be noted that the utility instruments described in this Example may also be associated or used with the imaging system or micro camera as embodied and described in FIGS. 7 and 8.

Supported by utility guide 56 are utility instruments 40-a and 40-b. Specifically, utility instrument 40-a comprises a light source 76 for illuminating a local area in which a utilitarian function is to be performed or a particular object. In one aspect, as shown, light source 76 comprises a fiber optic cable 72 that is inserted into and supported by one of the several utility apertures 102 formed within the utility guide 56. At its distal end is an illumination end 74 that functions to transmit optical energy or light into the surrounding area as conveyed by the fiber optic cable 72 along the length of the guidewire and as received from an operating source in the form of a power source (not shown). Light source 76 may comprise any type of lighting device or system commonly known in the art, such as a light emitting diode, fiber optic, incandescent, and others.

Utility instrument 40-b comprises a pair of micro forceps 160 actuatable by the user as desired to perform a cutting, scraping, or grasping utilitarian function. Micro forceps 160 may comprise various types known in the art, but are shown herein as biopsy forceps. Micro forceps 160 comprise two jaw components 168-a and 168-b that are configured to move with respect to one another, namely toward and away from one another, for one or more purposes. The jaw components 168-a and 168-b may be sized and configured to perform various utilitarian functions. Namely, the jaw components 168-a and 168-b may be designed as a clamping utility instrument, a cutting utility instrument, or a gathering utility instrument. For example, jaw components 168-a and 168-b may comprise a sharpened blade capable of cutting and/or excising tissue, etc. In another example, the jaw components 168-a and 168-b may comprise clamps designed to grasp tissue, stop blood flow in an artery or vein, seize excised tissue which can subsequently be recovered outside the body, or serve as a support element in assistance of another utility instrument. The micro forceps 160 may take on various other forms and be used in various other applications as will be recognized by one skilled in the art.

The jaw components 168-a and 168-b are supported by rigid jaw supports 164-a and 164-b, respectively, which are pivotally coupled to stem or base 172 via attachment means 176. Jaw supports 164-a and 164-b are preferably made of a biocompatible material capable of supporting the jaw components 168-a and 168-b, respectively. In addition, stem 172, jaw supports 164-a and 164-b, as well as jaw components 168-a and 168-b, are sized and configured to retract in and out of sheath 180. Specifically, during deployment of the utility device 10 through a lumen, the jaw components 168-a and 168-b are retracted and contained within the sheath 180. Upon reaching the local site where the utilitarian function is to be performed, the jaw supports 164-a and 164-b and the jaw components 168-a and 168-b supported thereon, are extended out of the sheath 180 to their functioning or operating position. When the utilitarian function is complete, these can again be retracted into the sheath 180.

Stem 172 is contained or supported within a transfer element, shown as flexible sheath 180, which is designed to also contain the cables or tendons (not shown) coupled to jaw supports 164-a and 164-b and that are used by the operator to actuate and control the movement and operation of each of the jaw components 168-a and 168-b. The flexible sheath 180 is sized and configured to extend through and be supported within utility aperture 102 formed within utility guide 56 as described above. Flexible sheath 180, which includes the tendons used to control the forceps 160, as well as the fiber optic cable 72 (all transfer elements 16) may be bundled in an umbilical 60, as shown, or may exist as individual elements.

It is noted that the particular operating specifics of the utility instruments, namely the biopsy forceps and the light source, shown in FIG. 9 are not critical for purposes of the discussion herein. Indeed, there are several designs existing in the art for providing utility instruments for use with the utility device described herein and for operating these within a lumen. What is of focus herein is the coordinated operation of the utility instruments, namely the light source 76 and the forceps 160, with the imaging system 14 (or micro camera) as discussed above.

It is also noted that each of the light source 76 and the forceps 160 may comprise various designs, configurations, material make-ups, etc. different from those shown and described herein, as will be apparent to one skilled in the art and each of which are contemplated by the present invention herein.

### EXAMPLE TWO

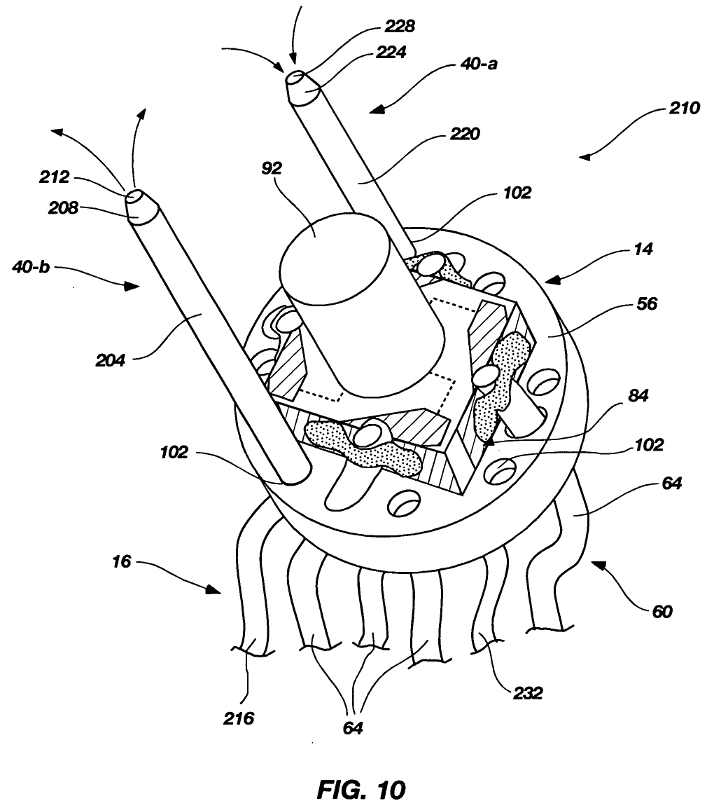

FIG. 10 illustrates a utility device 210 according one exemplary embodiment of the present invention. In this particular embodiment, utility device 210 comprises an imaging system 14 (or micro camera) as embodied and described in FIGS. 4-6, namely an SSID 84 and lens 92 combination supported on a utility guide 56 having a plurality of utility apertures 102 formed therein, and operated via conductive lines 64 (see FIGS. 4-6 for description).

Also supported by utility guide 56 are utility instruments 40-a and 40-b. Specifically, utility instrument 40-a comprises a fluid disperser 204 inserted into and supported within a utility aperture 102 formed in the utility guide 56 of the imaging device 14 in a similar manner as previously described utility instruments. Fluid dispenser 204 includes an elongate tubular member adapted to receive and transport fluid from a fluid source to a nozzle 208 having an opening 212 therein for emitting fluid, as illustrated by the arrows. Fluid dispenser 204 is fluidly coupled to an operating source (not shown), particularly a fluid source, via transfer element 216, wherein the fluid source is configured to provide pressurized fluid to the fluid dispenser 204 through a transfer element 16, which may be embodied as a tubular member 216. Fluid dispenser 204 may be deployed and utilized for a variety of purposes, such as to clear bodily fluids out of the way or to irrigate a local site during a surgical procedure, etc.

The utility device 210 is shown further comprising a negative pressure tube 220, also inserted into and supported within a utility aperture 102 formed within the utility guide 56 of the imaging device 14. Suction device 220 functions as a negative pressure device to pull fluids and other debris away from a local site. Suction device 220 includes a tubular member adapted to convey fluids and other debris sucked through nozzle 224 and opening 228 to a holding or storage container (not shown). Suction device 220 is fluidly coupled to an operating source (not shown), and particularly a negative pressure source, such as a vacuum, via transfer element 16, shown specifically as tubular member 232. Tubular member 216, 232, and conductive lines 64 (all transfer elements 16) may be bundled in an umbilical 60, as shown, or may exist as individual elements.

It is noted that the particular operating specifics of the utility instruments, namely the fluid disperser and the suction device, shown in FIG. 10 are not critical for purposes of the discussion herein. Indeed, there are several designs existing in the art for providing utility instruments for use with the utility device 210 described herein and for operating these within a lumen. What is of focus herein is the coordinated operation of the utility instruments, namely the fluid disperser 204 and the suction device 220, with the imaging system 14 (or micro camera) as discussed above.

It is also noted that each of the fluid disperser 204 and the suction device 220 may comprise various designs, configurations, material make-ups, etc. different from those shown and described herein, as will be apparent to one skilled in the art and each of which are contemplated by the present invention herein.

### EXAMPLE THREE

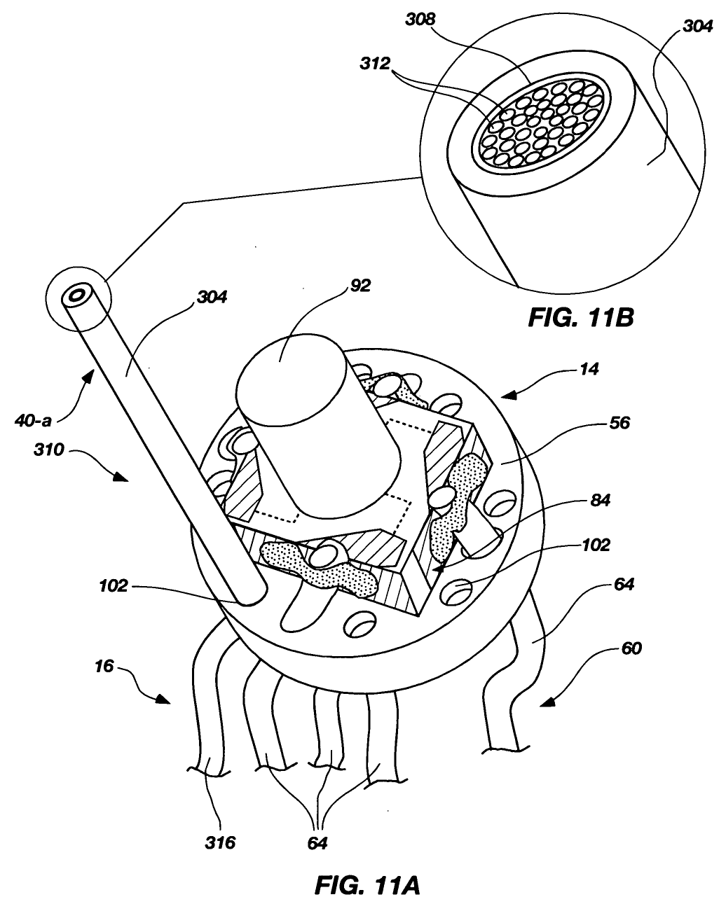

FIG. 11 illustrates a utility device 310 according one exemplary embodiment of the present invention. In this particular embodiment, utility device 310 comprises an imaging system 14 (or micro camera) as embodied and described in FIGS. 4-6, namely an SSID 84 and lens 92 combination supported on a utility guide 56 having a plurality of utility apertures 102 formed therein, and operated via conductive lines 64 (see FIGS. 4-6 for description).

Also supported by utility guide 56 is utility instrument 40-a. Specifically, utility instrument 40-a comprises a laser 304 that is inserted into and supported by utility aperture 102 formed within the utility guide 56 of the imaging device 14. Laser 304 may comprise one of various types of lasers depending upon the particular utilitarian function to be performed. For example, in the performance of an ablation function, the laser may be an excimer-type or other similar laser that enables the disintegration of targeted tissue without significant damage to healthy, non-targeted tissue. Another exemplary embodiment of a type of laser that may be employed is a Femtosecond laser, which is an extremely precise laser that ionizes the subject material, thus allowing pieces of it to be removed atom by atom. Each pulse of the laser is extremely short, lasting just 50 to 1,000 femtoseconds (quadrillionths of a second), which are too brief to transfer heat or shock to the material being cut. Therefore, cutting may occur with virtually no damage to the surrounding material.

Laser 304 is operably coupled to an operating source (not shown) through a suitable transfer element, shown as element 316, wherein the operating source is configured to generate laser light and to transfer this light through element 316 to a local site within a lumen.

FIG. 11-B illustrates a detailed view of the body of the laser 304, including an appropriately formed opening 308 allowing generated laser light 312 to pass therethrough.

It is noted that the particular operating specifics of the utility instrument, namely the laser 304, shown in FIGS. 11-A and 11-B are not critical for purposes of the discussion herein. Indeed, there are several designs existing in the art for providing utility instruments for use with the utility device described herein and for operating these within a lumen. What is of focus herein is the coordinated operation of the utility instruments, namely the laser 304, with the imaging system 14 (or micro camera) as discussed above.

It is also noted that the laser 304 may comprise various designs, configurations, material make-ups, etc. different from that shown and described herein, as will be apparent to one skilled in the art and each of which are contemplated by the present invention herein.

### EXAMPLE FOUR

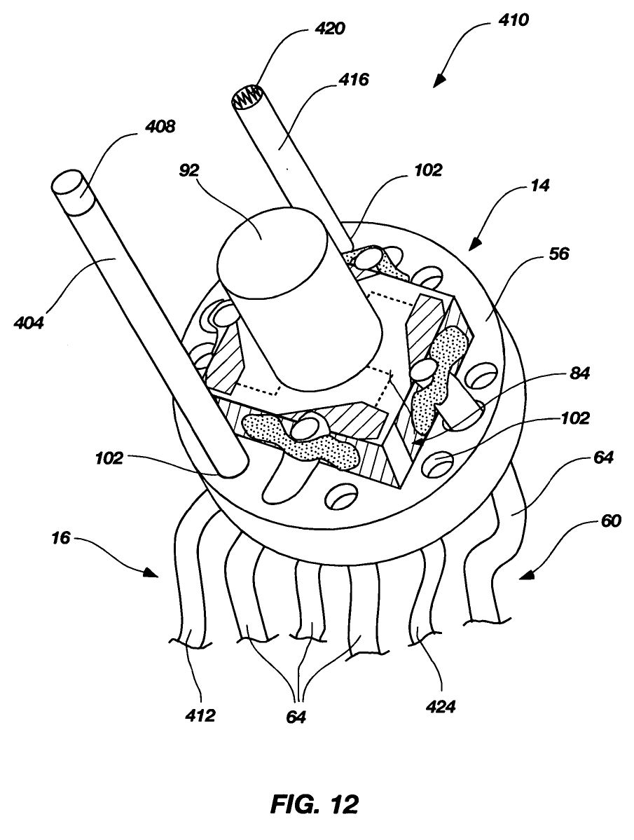

FIG. 12 illustrates a utility device 410 according one exemplary embodiment of the present invention. In this particular embodiment, utility device 410 comprises an imaging system 14 (or micro camera) as embodied and described in FIGS. 4-6, namely an SSID 84 and lens 92 combination supported on a utility guide 56 having a plurality of utility apertures 102 formed therein, and operated via conductive lines 64 (see FIGS. 4-6 for description).

Also supported by utility guide 56 are utility instruments 40-a and 40-b. Specifically, utility instrument 40-a comprises an acoustical device 404 configured to provide acoustical energy, such as ultrasound, to a local target site within a lumen. The acoustical device 404 is inserted and supported within a utility aperture 102 formed within utility guide 56 of the imaging device 14. At the distal end of the acoustical device 404 is a transducer element 408 configured to emit sound waves or acoustical energy. The transducer element 408 may comprise any type known in the art and is operably coupled to an operating source (not shown) through a transfer element 16, namely element 412, which comprises any known conduit of acoustical energy. The operating source, which is an acoustical energy generator, is configured to generate various magnitudes of acoustical energy and to supply this energy through element 412 to the acoustical device 404.

FIG. 12 further illustrates and utility device 410 further comprises an acoustical sensor 416 configured to receive, via a sensor element 420 formed in the distal end of the acoustical sensor, the waveforms reflected or refracted off the targeted object as emitted from the acoustical device 404. The acoustical sensor 416 is also inserted into and supported by a utility aperture 102 formed within the utility guide 56. The acoustical sensor 416 is operably coupled to an operating source (not shown) through transfer element 424, wherein the operating source is configured to receive, process, and/or store the signals captured by the sensor element 420. Transfer element 424 may comprise any suitable means for conveying the captured acoustical energy or waveforms to the operating source for later analysis.

Therapeutic ultrasound systems have proven effective in enhancing transdermal drug delivery, ablating pathological tissue and non-invasively breaking up concretions within the body. To achieve maximum therapeutic benefits, it is desirable to deliver ultrasound energy as directly as possible to the treatment site. Therefore, the inclusion of a utility instrument in the form of an acoustical device as described above onto an imaging system as described herein will have significant benefits.

It is noted that the particular operating specifics of the utility instruments, namely the acoustical device 404 and the acoustical sensor 416, shown in FIG. 12 are not critical for purposes of the discussion herein. Indeed, there are several designs existing in the art for providing utility instruments for use with the utility device described herein and for operating these within a lumen. What is of focus herein is the coordinated operation of the utility instruments, namely the acoustical device 404 and the acoustical sensor 416, with the imaging system 14 (or micro camera) as discussed above.

It is also noted that each of the acoustical device 404 and the acoustical sensor 416 may comprise various designs, configurations, material make-ups, etc. different from those shown and described herein, as will be apparent to one skilled in the art and each of which are contemplated by the present invention herein.

As indicated before, the above examples are not intended to be limiting in any way. For example, it is contemplated that the present invention may be embodied to comprise utility instruments in the form of hemostasis/cauterization devices, drug delivery or medication depositing devices, stent deployment devices, CTO penetrators, various biopsy devices, filters, laparoscopy devices, angioplasty balloons, and a variety of others.

In addition, it is also contemplated that the present invention may be used to provide a utilitarian function with multiple superimposed images formed from two or more imaging devices. For example, it is contemplated that two cameras can be employed to distinguish between tissues, wherein one tissue has previously been dye saturated. Using a computer, the images from the multiple imaging devices can be superimposed to distinguish the dyed tissue from the tissue free of any dye.

There are numerous applications for the present invention, all of which cannot be recited herein. Utilizing the present invention imaging technology coupled with current micromachining technology used to produce micro utility instruments such as those discussed herein, provides the ability to locate a camera within a lumen previously unattainable by prior art systems. Plus, the coordinated operation of the imaging device with a micro utility instrument provides the ability to perform highly precise and targeted utilitarian functions at one or more local sites within the lumen, while capturing the function being performed in an image viewable by the user. Such will give the user a great amount of flexibility and added control over prior related systems in that the user will be able to see precisely the targeted object and the area surrounding the targeted object during the performance of the utilitarian function.

As will be appreciated, an imaging device in accordance with principles of the invention can be made very small, and is useful in solving certain imaging problems, particularly, that of imaging a remote location distal of a small opening, for example in human anatomy distal of a small orifice or luminal space (anatomical or artificial, such as a trocar lumen), or via a small incision, etc., the configuration facilitates miniaturizations, and simplifies assembly. In fact, because of the solid state nature of the SSID and other features, these cameras can be made to be micron-sized for reaching areas previously inaccessible, such as dental/orthodontics, fallopian tubes, heart, lungs, vestibular region of ear, and the like. Larger lumens or cavities can be viewed with a greater degree of comfort and less patient duress, including the colon, stomach, esophagus, or any other similar anatomical structures. Additionally, such devices can be used for in situ tissue analysis. All of this combined with the technology available to create miniature or micro utility instruments functions to provide a highly advantageous utility device or system, wherein a user is capable of performing highly precise and controlled utilitarian functions within a lumen that are viewable in real-time.

Some of the advantages recognized by the present invention, which are not limiting in any way, include, an improved precision and new standard in microsurgery and other luminal explorations, reduction of costs and increased efficiency of surgical procedures or other utilitarian functions, less intrusive equipment used to perform a procedure or function, enabling microsurgery and other lumen investigation and the functions performed therein to be more accurate with more controls in small manipulation areas, an increase in the skill of the practitioner or user to perform utilitarian functions, an ability to enhance the skill and performance of a user due to the added or increase ability to perform viewable functions, and others.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited, except in the specification. Accordingly, the scope of the invention should be determined solely by the appended claims and their legal equivalents, rather than by the descriptions and examples given above.

What is claimed and desired to be secured by Letters Patent is:

1. A miniaturized utility device having integrated optical capabilities for use on a high aspect ratio system, said miniaturized utility device comprising:
(a) a micro imaging device comprising:
a utility guide supported at the distal end of a high aspect ratio system, said utility guide having a plurality of utility apertures formed therein;
a solid state imaging device carried by said utility guide, said solid state imaging device having an imaging array on a top surface, and a conductive element, said imaging array being electrically
coupled to said conductive element;
(b) a lens optically coupled to said imaging array to form a micro camera;
(c) a micro utility instrument operably supported within one of said utility apertures for coordinated operation with said micro camera at a local site, said micro utility instrument configured to perform a designated function viewable in real-time via a camera image generated by said micro camera; and
(d) an umbilical carried by at least one of the apertures and comprising a plurality of transfer elements, including a conductive line, for operably connecting said micro camera and said micro utility instrument, said conductive line electrically coupled to said conductive element of said solid state imaging device.

2. The miniaturized utility device of claim 1, wherein said utility guide is configured to support multiple utility instruments.

3. The miniaturized utility device of claim 1, wherein said high aspect ratio system is selected from the group consisting of a catheter and a guidewire, each configured for biomedical use.

4. The miniaturized utility device of claim 1, wherein said lens comprises a GRIN lens.

5. The miniaturized utility device of claim 1, further comprising an adaptor configured to support said lens and provide electrical communication between said solid state imaging device and said conductive line.

6. The miniaturized utility device of claim 1, wherein at least one of said plurality of transfer elements comprises a conductive line for electrically connecting said micro utility instrument.

7. The miniaturized utility device of claim 1, wherein said at least one of said plurality of transfer elements comprises an actuation line for enabling mechanical actuation of said micro utility instrument.

8. The miniaturized utility device of claim 1, wherein said at least one of said plurality of transfer elements comprises an optical fiber for delivering light energy to said micro utility instrument.

9. The miniaturized utility device of claim 1, wherein said at least one of said plurality of transfer elements comprises an acoustical conduit for delivering acoustical energy to and from said micro utility instrument.

10. The miniaturized utility device of claim 1, wherein said at least one of said plurality of transfer elements comprises a tubular member for transferring fluid to and from said micro utility instrument.

11. The miniaturized utility device of claim 1, wherein said micro utility instrument is selected from the group consisting of a light source, forceps, a laser, an acoustical device, a fluid disperser, a suction device, an acoustical device, an acoustical sensor, hemostasis/cauterization devices, drug delivery or medication depositing devices, stent deployment devices, CTO penetrators, various biopsy devices, filters, laparoscopy devices, angioplasty balloons,

12. The miniaturized utility device of claim 1, further comprising a plurality of micro utility instruments configured for coordinated operation with a plurality of imaging devices.

13. The miniaturized utility device of claim 1, further comprising at least one operating source operably coupled to said imaging device and at least one operating source operably coupled to said micro utility instrument, said respective operating sources configured to facilitate the respective operation and performance of said imaging device and said micro utility instruments.

14. A miniaturized utility system having integrated optical capabilities for use on a high aspect ratio system, said miniaturized utility system comprising:
(a) a utility guide supported at a distal end of a first high aspect ratio system, said utility guide having a plurality of utility apertures formed therein;
(b) a solid state imaging device carried by said utility guide, said solid state imaging device comprising:
i) an imaging array on a top surface, and
ii) a conductive element on a side surface, said imaging array being electrically coupled to said conductive element;
(c) a lens optically coupled to said imaging array to form a micro camera; and
(d) a micro utility instrument operably supported on a distal end of a second high aspect ratio system configured to interact with said first high aspect ratio system to provide coordinated operation of said micro utility instrument with said micro camera at a local site, said micro utility instrument configured to perform a designated function viewable in real-time via a camera image generated by said micro camera.

15. The miniaturized utility system of claim 14, wherein said micro utility instrument releasably engages and is supported within said utility apertures upon proper alignment and positioning of said first and second high aspect ratio systems.

16. The miniaturized utility system of claim 14, wherein said first and second high aspect ratio systems are each selected from the group consisting of a biomedical device and a non-biomedical device.

17. The miniaturized utility system of claim 16, further comprising a transfer element in the form of a conductive line for electrically connecting said conductive element on said side surface of said solid state imaging device.

18. The miniaturized utility device of claim 17, further comprising an adaptor configured to support said lens and provide electrical communication between said solid state imaging device and said conductive line.

19. The miniaturized utility system of claim 14, further comprising at least one transfer element for operably supporting said micro utility instrument on said second high aspect ratio system.

20. The miniaturized utility system of claim 14, wherein said lens comprises a GRIN lens.

21. A miniaturized utility device having integrated optical capabilities for use on a high aspect ratio system, said miniaturized utility device comprising:
(a) a micro camera comprising:
(i) a solid state micro imaging device including, as an integral structure, an imaging array electrically coupled to a conductive pad, said solid state imaging device further including at least one utility aperture passing therethrough;
(ii) a lens optically coupled to said imaging array; and
(b) a micro utility instrument configured for coordinated operation with said imaging device at a common local site, said micro utility instrument configured to perform a designated function viewable in real-time via a camera image generated by said micro camera.

22. The miniaturized utility device of claim 21, further comprising an umbilical containing a plurality of transfer elements for operably connecting said micro camera and said micro utility instrument.

23. The miniaturized utility device of claim 21, wherein said utility aperture is located in a position radially offset from a center axis of said solid state imaging device.

24. The miniaturized utility device of claim 21, wherein said utility aperture is located in an annular position around a perimeter edge of said solid state imaging device.

25. The miniaturized utility device of claim 21, wherein said utility aperture is located in a random position about said solid state imaging device.

26. A miniaturized utility device having integrated optical capabilities, comprising:
(a) a solid state micro imaging device including an imaging array;
(b) a GRIN lens optically coupled to the imaging array of said solid state imaging device to form a micro camera; and
(c) a micro utility instrument configured to perform a utilitarian function concurrent with an imaging function performed by said micro camera at a local site, said utilitarian function viewable in real-time via a camera image generated by said micro camera.

27. A miniaturized utility device having integrated optical capabilities, comprising:
(a) multiple imaging arrays supported by a solid state micro imaging device, said solid state imaging device comprising:
i) at least one mountable surface, and
ii) a conductive element disposed on said at least one mountable surface, said imaging arrays being electrically coupled to said conductive element;
(b) multiple lenses optically coupled to said multiple imaging arrays, respectively, to form multiple micro cameras on said solid state imaging device; and
(c) at least one micro utility instrument configured to perform a utilitarian function concurrent with an imaging function performed by at least one of said micro cameras at a common local site, said utilitarian function viewable in real-time via a camera image generated by at least one of said micro cameras.

28. A miniaturized utility device having integrated optical capabilities comprising:
(a) a plurality of solid state micro imaging devices supported along a length of a high aspect ratio system, each of said solid state imaging devices comprising:
i) at least one imaging array disposed on a top surface, and
ii) a conductive element on a side surface, said imaging array being electrically coupled to said conductive element;
(b) a plurality of lenses optically coupled to said imaging arrays to form a plurality of micro cameras;
(c) a plurality of micro utility instruments configured for coordinated operation with said micro cameras at a plurality of common local sites, said micro utility instruments configured to perform a designated function viewable in real-time via a camera image generated by each of said micro cameras; and
(d) a plurality of transfer elements for operably connecting said micro cameras and said micro utility instruments.

29. A method of operating a miniaturized utility device having additional optical capabilities, comprising:
(a) optically coupling a lens to an imaging array of a solid state micro imaging device to form a micro camera supported on a high aspect ratio system;
(b) defining a plurality of conductive paths, including a path to said imaging device;
(c) powering said solid state imaging device through said conductive path to said imaging device;
(d) positioning a micro utility instrument at a common local site with said micro camera;
(e) coordinating, at said common local site, a performance of a utilitarian function with the operation of said micro camera, said utilitarian function being performed by said micro utility instrument supported by said high aspect ration system;
(f) transmitting a signal from said solid state imaging device through a second of said plurality of conductive paths, said signal corresponding to a captured image of said local site at which said utilitarian function is being performed; and
(g) processing said signal received from said solid state imaging device to form a camera image of said local site.

30. A method of performing a viewable utilitarian function at one or more local sites within a lumen, said method comprising:
(a) inserting a high aspect ratio device into a luminal opening, said high aspect ratio system comprising at least one micro camera including a lens optically coupled to an imaging array of a solid state imaging device;
(b) illuminating at least one local site around the lens within or beyond the luminal opening;
(c) receiving light or photon energy in the lens reflected by contents within or beyond the luminal opening, thereby providing focused light or photon energy at the imaging array;
(d) positioning a micro utility instrument at a common local site with said micro camera;
(e) coordinating, at said at least one local site, the performance of a utilitarian function with the operation of said micro camera, said utilitarian function being performed by said micro utility instrument supported by said high aspect ratio system;
(f) converting the focused light or photon energy to digital data, said digital data corresponding to a captured image of said local site at which said utilitarian function is being performed; and
(g) processing said digital data into a camera image of said at least one local site for viewing on a viewing source remote from said micro camera.
